(19) United States
(12) Patent Application Publication
(10) Pub. No.: US 2005/0239625 A1
(43) Pub. Date: Oct. 27, 2005

(54) Folding apparatus

(75) Inventor: Ulrich Seyffert, Syrau (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach am Main (DE)

(21) Appl. No.: 11/051,274

(22) Filed: Feb. 4, 2005

(30) Foreign Application Priority Data
Feb. 5, 2004 (DE) 10 2004 005 890.3

(51) Int. Cl. B31F 1/00

(52) U.S. Cl. 493/439

(57) ABSTRACT

A folding apparatus that permits the production of a wide range of folded products at a relatively low cost and requires a minimal amount of space is provided. The folding apparatus includes a main former for receiving webs up to the maximum web width and a smaller former for receiving webs of up to approximately one-half of the maximum web width. The main former includes a main former nose and the smaller former includes a smaller former nose. The main and smaller formers are arranged such that the main former nose and the smaller former nose lie substantially in a common perpendicular plane when viewed from a side of the folding apparatus such that a partial web stream emerging from the main former and a partial web stream emerging from the smaller former can undergo further processing almost congruently after folding.

### FIELD OF THE INVENTION

The invention relates to an apparatus for folding a paper web.

### BACKGROUND OF THE INVENTION

An apparatus for longitudinally folding a plurality of paper webs of equal width in a web-fed rotary press is disclosed in DE 42 04 254 A1. In the apparatus, two out of three folding formers are arranged above one another. The disclosed arrangement enables the processing of partial webs that are divided into two or three parts. However, it is not possible to fold an undivided web of maximum web width using one of the three folding formers.

### BRIEF SUMMARY OF THE INVENTION

A general object of the present invention is to provide a folding apparatus that enables the production of a wide variety of folded products at a relatively low cost but, nevertheless, in a relatively space-saving manner.

According to the present invention, an additional smaller former for half a web width is arranged in a space-saving manner between the frame walls of a former for the full web width that is configured as a main former. More particularly, the smaller former is arranged asymmetrically and approximately centrally to half of the maximum web width in the upper region of the main former. The noses of both formers lie in exactly or as much as possible (e.g, a very small offset in the millimeter range) the same perpendicular plane when viewed from the side. This allows the further processing of the partial streams almost congruently after folding. The vertical arrangement is preferably selected such that the overall height of the former arrangement does not exceed, or only exceeds to a slight extent, the headroom that is required for the operators of the folder and the operation of the main former is not impeded.

The folding apparatus of the present invention can be used to longitudinally fold partial webs that are printed in the same way in each case next to one another as an entire web and subsequently cut longitudinally to half the web width for the manufacture of a product, for example, in double production. The folding apparatus can also be used to fold full webs up to the maximum web width that are printed in any desired manner for the manufacture of products in single production. The folding apparatus further can be used to fold partial webs that are cut longitudinally to half the web width for the manufacture of two products.

Using simple mechanisms and requiring only a relatively narrow space, the present invention allows operation with one stream up to the maximum web width using the large folding former, and operation with two streams of in each case half the web width using two folding formers (e.g., for double production of a product, or for single production of two products).

The folding apparatus can be used to fold at least one web of up to a maximum web width, which web can optionally be divided into two partial streams of equal width. The folding apparatus includes two formers that are arranged above one another. A first former for half a web width is arranged in the region of the full web width above a second former for the full web width, which is configured as a main former. The first former and the main former are arranged such that the noses of both formers lie as much as possible in one perpendicular plane when viewed from the side and the partial web streams can be further processed almost congruently after folding.

The invention will be described in greater detail below in the context of an exemplary embodiment.

### BRIEF DESCRIPTION OF THE DRAWINGS

FIG. 1 is a schematic view of an exemplary folding apparatus in accordance with the present invention that includes with two folding formers.

FIG. 2. is a schematic side view of the folding apparatus of FIG. 1.

### DETAILED DESCRIPTION OF THE INVENTION

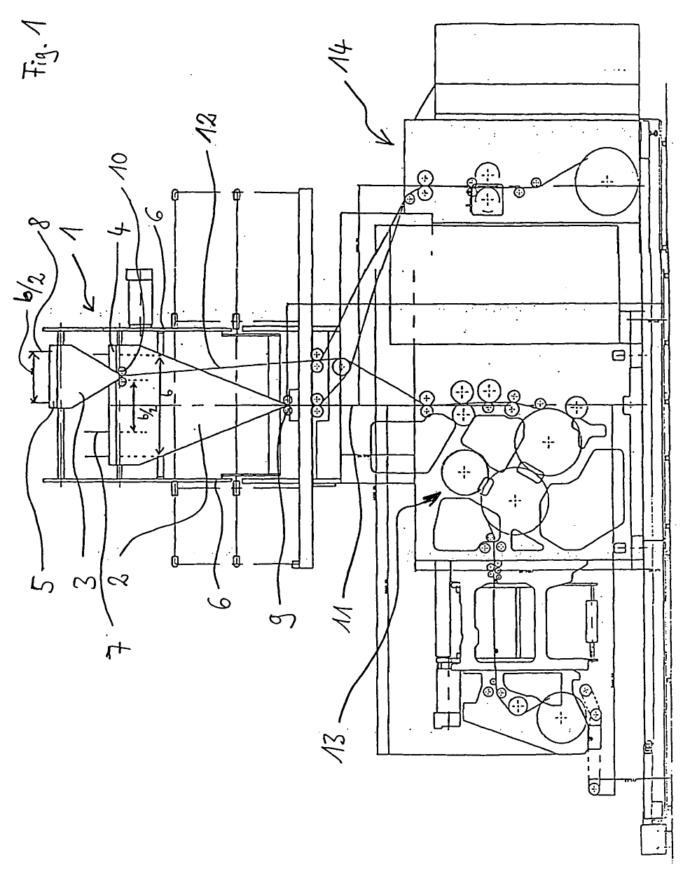

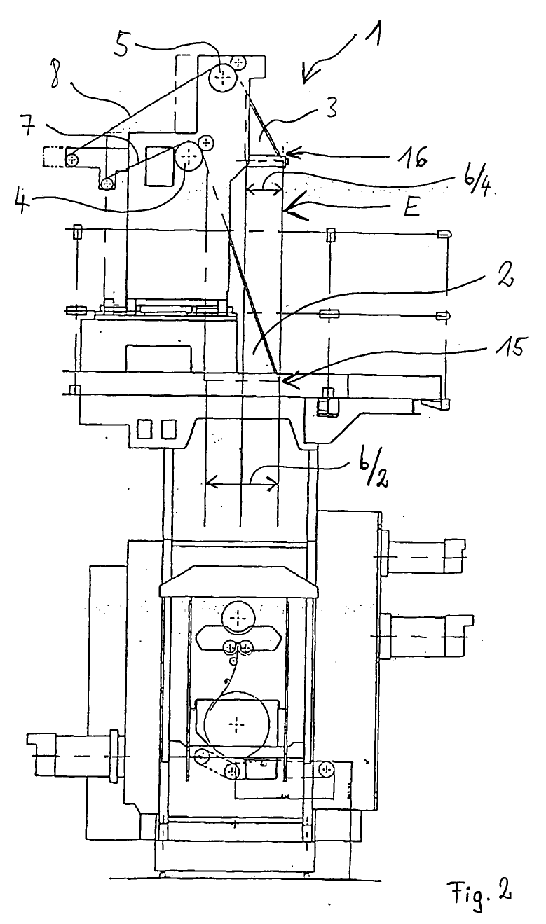

Referring now to FIG. 1 of the drawings, a former 2 which is configured as a main former is shown for the longitudinal folding of webs up to a maximum web width b or webs having a partial width. The main former 2 is arranged between side walls 6. A former roller 4 is arranged in a known manner at the inlet for feeding at least one web 7, and a pair of folding rollers 9 is arranged at the outlet. A smaller former 3 for half a web width is arranged above the main former 2. The smaller former 3 is arranged approximately centrally with respect to half of the maximum web width b. The smaller former 3 also has a former roller 5 at the inlet and a pair of folding rollers 10 at the outlet in a known manner. The smaller former 3 can overlap the main former 2 somewhat, so as to save space, without adversely influencing the function or operating characteristics of the main former 2. The formers 2, 3 have former noses 15, 16 which lie exactly in a common perpendicular plane E when viewed from the side or which lie substantially in a common plane E (i.e., as much as possible), for example with a very small offset in the range of millimeters (cf. FIG. 2). substantially

In the illustrated embodiment, the large main former 2 that longitudinally folds the partial web 7 is designed exclusively for longitudinally folding webs up to the maximum web width b. In turn, the smaller folding former 3 that longitudinally folds the part web 8 and is arranged above the large main former 2 so as to engage into the folding region of the main former to a depth of approximately a quarter of the web width b is designed for longitudinally folding webs 8 up to half the web width b. As a result, the two longitudinally folded streams 11, 12 that comprise the partial webs 7 and 8 emerge on top of one another in each case via two folding rollers 9 and 10. The folding rollers 10 associated with the small folding former 3 are preferably mounted on one side of the frame on one side in the manner of a cantilever. The smaller former 3 preferably can be displaced transversely with respect to the running direction of the web 8.

The production variant for which the additional small folding former 3 is provided is as follows:

A web having the full width b is cut longitudinally in a turner unit (not shown) having a cutting device. One partial web 7 is turned onto the center of the main former 2 and the other partial web 8 is turned onto the center of the small former 3. The partial web 7 emerges at the outlet of the main former 2 as a stream 11 and the partial web 8 emerges at the outlet of the small former 3 as a stream 12 in a precisely congruent or almost congruent manner as seen from the side (cf. FIG. 2). The arrangement of the former noses 15, 16 in the perpendicular plane E enables this congruent or almost congruent exit of the partial webs 7, 8. Both streams 11, 12 are fed via tension and stream guide rollers (not illustrated) to one or two folding or cutting devices 13, 14 having product delivery systems. The cutting device 14 can also be referred to as a cutter or cutting unit, by means of which the longitudinally folded partial web or full web is transversely cut into products and delivered.

Simple production of a product can also be carried out in the folding device 13 given appropriate image-setting on the printing form and combination of both partial webs 7, 8 via the large main former 2 (in such as case the partial webs 7, 8 are printed differently). The same applies, in a similar way, for the processing of undivided webs. When two partial streams each of which is half the web width b are being processed, the apparatus serves, for example, for production in what is referred to as a 16-page machine (ca. A4) of 4×4 pages which are delivered via the cutting device 14, or of 2×8 pages which are delivered by the folding device 13.

### LIST OF REFERENCE NUMERALS

1 Folding-former arrangement
2 Former
3 Small former
4 Former roller
5 Former roller
6 Side wall
7 Partial web
8 Partial web
9 Folding rollers
10 Folding rollers
11 Stream
12 Stream
13 Folding or cutting device
14 Folding or cutting device
15 Former nose
16 Former nose

1. A folding apparatus for folding a web of a maximum web width or that is divided into two partial web streams of equal width comprising:
a main former for receiving webs up to the maximum web width; and
a smaller former for receiving webs of up to approximately one-half of the maximum web width
wherein the main former includes a main former nose and the smaller former includes a smaller former nose and the main and smaller formers are arranged such that the main former nose and the smaller former nose lie substantially in a common perpendicular plane when viewed from a side of the folding apparatus such that a partial web stream emerging from the main former and a partial web stream emerging from the smaller former can undergo further processing almost congruently after folding.

2. A folding apparatus according to claim 1, wherein the smaller former is laterally displaceable.

3. A folding apparatus according to claim 1, wherein the partial web streams emerging from the main former and the smaller former can be fed to a folding or cutting device.

4. A folding apparatus according to claim 1, wherein the partial web streams emerging from the main former and the smaller former can be fed to separate apparatuses for further processing.

5. A folding apparatus according to claim 1, wherein the smaller former is arranged within lateral boundaries defined by the maximum web width receivable by the main former.
